(19) United States
(12) Patent Application Publication
(10) Pub. No.: US 2011/0275263 A1
(43) Pub. Date: Nov. 10, 2011

(54) FLAME RESISTANT TEXTILE MATERIALS

(76) Inventors: Shulong Li, Spartanburg, SC (US); J. Travis Greer, Chesnee, SC (US); James D. Cliver, Roebuck, SC (US); Jack W. Spoon, Spartanburg, SC (US)

(21) Appl. No.: 12/777,209

(22) Filed: May 10, 2010

(51) Int. Cl. B32B 27/12; D03D 13/00; B32B 5/02; D03D 15/00

(52) U.S. Cl. 442/142; 442/181; 442/203; 442/141

(57) ABSTRACT

A flame resistant textile material comprises cellulosic fibers and inherent flame retardant fibers. The flame resistant textile material can be treated with one or more flame retardant treatments to impart flame resistance to the cellulosic fibers.

### TECHNICAL FIELD OF THE INVENTION

This patent application is directed to flame resistant textile materials.

### BACKGROUND OF THE INVENTION

Flame resistant fabrics are useful in many applications, including the production of garments worn by personnel in a variety of industries or occupations, such as the military, electrical (for arc protection), petroleum chemical manufacturing, and emergency response fields. Cellulosic or cellulosic-blend fabrics have typically been preferred for these garments, due to the relative ease with which these fabrics may be made flame resistant and the relative comfort of such fabrics to the wearer.

Notwithstanding the popularity of cellulosic or cellulosic-blend flame resistant fabrics, existing fabrics do suffer from limitations. The flammability performance of many cellulosic flame resistant fabrics is not sufficient to meet the demanding requirements of certain industries. In order to meet these requirements, inherent flame resistant fibers (e.g., meta-aramid fibers, such as NOMEX® fiber from E. I. du Pont de Nemours and Company) are often employed, which increases the cost of the fabrics. Accordingly, a need remains to provide alternative flame resistant fabrics that are capable of meeting applicable flame resistance standards.

### BRIEF SUMMARY OF THE INVENTION

In a first series of embodiments, the invention provides textile materials made from yarns comprising cellulosic fibers and yarns comprising polyoxadiazole fibers. In particular, the invention provides a textile material having a first surface and a second surface opposite the first surface. The textile material comprises a plurality of first yarns disposed in a first direction. The first yarns comprise cellulosic fibers. The textile material also comprises a plurality of second yarns disposed in a second direction substantially perpendicular to the first direction. The second yarns comprise polyoxadiazole fibers. The first and second yarns are disposed in a patternwise arrangement in which the first yarns are predominantly disposed on the first surface of the textile material and the second yarns are predominantly disposed on the second surface of the textile material. Such an arrangement of the yarns provides a fabric in which at least one surface of the fabric exhibits the flame resistant properties attributed to polyoxadiazole fibers (i.e., the second surface of the textile material on which the second yarns are predominantly disposed) while using less of the polyoxadiazole fibers than would be used to produce a textile material in which both sets of yarns are identical (i.e., both sets of yarns contain polyoxadiazole fibers). Furthermore, by incorporating cellulosic fibers, such a fabric is able to deliver the levels of comfort to which personnel have become accustomed.

In an additional series of embodiments, the invention provides textile materials that have been treated with one or more flame retardant treatments to render the textile materials more flame resistant. These textile materials can comprise cellulosic fibers in addition to one or more inherent flame resistant fibers (e.g., polyoxadiazole fibers, polysulfonamide fibers, poly(benzimidazole) fibers, poly(phenylenesulfide) fibers, meta-aramid fibers, para-aramid fibers, and mixtures thereof). These additional embodiments are believed to be desirable due to the fact that they provide a flame resistant textile material using a lower amount of inherent flame resistant fibers, which tend to be relatively expensive, while also providing a textile material that is comfortable to wear (e.g., a textile material exhibiting favorable hand).

Thus, in another embodiment, the invention provides a textile material comprising a plurality of first yarns. The first yarns comprise cellulosic fibers and fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof. The textile material further comprises a finish applied to the textile material. The finish comprises a phosphorous-containing compound polymerized within at least a portion of the cellulosic fibers. The phosphorous-containing compound is a product produced by heat-curing and oxidizing a reaction mixture comprising (i) a first chemical selected from the group consisting of tetrahydroxymethyl phosphonium salts, condensates of tetrahydroxymethyl phosphonium salts, and mixtures thereof, and (ii) a cross-linking agent. The cross-linking agent can be selected from the group consisting of urea, guanidines, guanyl urea, glycoluril, ammonia, ammonia-formaldehyde adducts, ammonia-acetaldehyde adducts, ammonia-butyraldehyde adducts, ammonia-chloral adducts, glucosamine, polyamines, glycidyl ethers, isocyanates, blocked isocyanates, and mixtures thereof.

In another embodiment, the invention provides a textile material having a first surface and a second surface opposite the first surface. The textile material comprises a plurality of first yarns disposed in a first direction and a plurality of second yarns disposed in a second direction substantially perpendicular to the first direction. The first yarns comprise cellulosic fibers, and the second yarns comprise fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof. The textile material further comprises a finish applied to the textile material. The finish comprises a phosphorous-containing compound, and the phosphorous-containing compound comprises a plurality of pentavalent phosphine oxide groups having amide linking groups covalently bonded thereto. Furthermore, at least a portion of the pentavalent phosphine oxide groups have three amide linking groups covalently bonded thereto. In the textile material, the first and second yarns are disposed in a patternwise arrangement in which the first yarns are predominantly disposed on the first surface of the textile material and the second yarns are predominantly disposed on the second surface of the textile material.

In another embodiment, the invention provides a textile material having a first surface and a second surface opposite the first surface. The textile material comprises a plurality of first yarns disposed in a first direction and a plurality of second yarns disposed in a second direction substantially perpendicular to the first direction. The first yarns comprising cellulosic fibers, and the second yarns comprising fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof. The textile material further comprises a finish applied to the textile material, and the finish comprises a phosphorous-containing compound polymerized within at least a portion of the cellulosic fibers. The phosphorous-containing compound is a product produced by heat-curing and oxidizing a reaction mixture comprising (i) a first chemical selected from the group consisting of tetrahydroxymethyl phosphonium salts, condensates of tetrahydroxymethyl phosphonium salts, and mixtures thereof, and (ii) a cross-linking agent. The cross-linking agent can be selected from the group consisting of urea, guanidines, guanyl urea, glycoluril, ammonia, ammonia-formaldehyde adducts, ammonia-acetaldehyde adducts, ammonia-butyraldehyde adducts, ammonia-chloral adducts, glucosamine, polyamines, glycidyl ethers, isocyanates, blocked isocyanates, and mixtures thereof. In the textile material, the first and second yarns are disposed in a patternwise arrangement in which the first yarns are predominantly disposed on the first surface of the textile material and the second yarns are predominantly disposed on the second surface of the textile material.

### DETAILED DESCRIPTION OF THE INVENTION

As noted above, the invention provides flame resistant textile materials. As utilized herein, the term “flame resistant” refers to a material that burns slowly or is self-extinguishing after removal of an external source of ignition. The flame resistance of textile materials can be measured by any suitable test method, such as those described in National Fire Protection Association (NFPA) 701 entitled “Standard Methods of Fire Tests for Flame Propagation of Textiles and Films,” ASTM D6413 entitled “Standard Test Method for Flame Resistance of Textiles (vertical test)”, NFPA 2112 entitled “Standard on Flame Resistant Garments for Protection of Industrial Personnel Against Flash Fire”, ASTM F1506 entitled “The Standard Performance Specification for Flame Resistant Textile Materials for Wearing Apparel for Use by Electrical Workers Exposed to Momentary Electric Arc and Related Thermal Hazards”, and ASTM F1930 entitled “Standard Test Method for Evaluation of Flame Resistant Clothing for Protection Against Flash Fire Simulations Using an Instrumented Manikin.”

The textile materials of the invention generally comprise fabrics formed from one or more pluralities or types of yarns. The textile materials can be formed from a single plurality or type of yarn (e.g., the fabric can be formed solely from yarns comprising a blend of cellulosic fibers and inherent flame resistant fibers, such as polyoxadiazole fibers), or the textile material can be formed from several pluralities or different types of yarns (e.g., the fabric can be formed from a first plurality of yarns comprising cellulosic fibers and polyamide fibers and a second plurality of yarns comprising an inherent flame resistant fiber, such as polyoxadiazole fibers).

The yarns used in making the textile materials of the invention can be any suitable type of yarn. Preferably, the yarns are spun yarns. In such embodiments, the spun yarns can be made from a single type of staple fiber (e.g., spun yarns formed solely from cellulose fibers or spun yarns formed solely from inherent flame resistant fibers), or the spun yarns can be made from a blend of two or more different types of staple fibers (e.g., spun yarns formed from a blend of cellulose fibers and thermoplastic synthetic staple fibers, such as polyamide fibers). Such spun yarns can be formed by any suitable spinning process, such as ring spinning, air-jet spinning, or open-end spinning. In certain embodiments, the yarns are spun using a ring spinning process (i.e., the yarns are ring spun yarns).

The textile materials of the invention can be of any suitable construction. In other words, the yarns forming the textile material can be provided in any suitable patternwise arrangement producing a fabric. Preferably, the textile materials are provided in a woven construction, such as a plain weave, basket weave, twill weave, satin weave, or sateen weave. Suitable plain weaves include, but are not limited to, ripstop weaves produced by incorporating, at regular intervals, extra yarns or reinforcement yarns in the warp, fill, or both the warp and fill of the textile material during formation. Suitable twill weaves include both warp-faced and fill-faced twill weaves, such as 2/1, 3/1, 3/2, 4/1, 1/2, 1/3, or 1/4 twill weaves. In certain embodiments of the invention, such as when the textile material is formed from two or more pluralities or different types of yarns, the yarns are disposed in a patternwise arrangement in which one of the yarns is predominantly disposed on one surface of the textile material. In other words, one surface of the textile material is predominantly formed by one yarn type. Suitable patternwise arrangements or constructions that provide such a textile material include, but are not limited to, satin weaves, sateen weaves, and twill weaves in which, on a single surface of the fabric, the fill yarn floats and the warp yarn floats are of different lengths.

As noted above, the textile materials of the invention contain yarns comprising cellulosic fibers. As utilized herein, the term “cellulosic fibers” is used to refer to fibers composed of, or derived from, cellulose. Examples of suitable cellulosic fibers include cotton, rayon, linen, jute, hemp, cellulose acetate, and combinations, mixtures, or blends thereof. Preferably, the cellulosic fibers comprise cotton fibers.

In those embodiments of the textile material comprising cotton fibers, the cotton fibers can be of any suitable variety. Generally, there are two varieties of cotton fibers that are readily available for commercial use in North America: the American Upland variety (Gossypium hirsutum) and the American Pima variety (Gossypium barbadense). The cotton fibers used as the cellulosic fibers in the invention can be cotton fibers of either the American Upland variety, the American Pima variety, or a combination, mixture, or blend of the two. Generally, cotton fibers of the American Upland variety, which comprise the majority of the cotton used in the apparel industry, have lengths ranging from about 0.875 inches to about 1.3 inches, while the less common fibers of the American Pima variety have lengths ranging from about 1.2 inches to about 1.6 inches. Preferably, at least some of the cotton fibers used in the invention are of the American Pima variety, which are preferred due to their greater, more uniform length.

In those embodiments in which the textile material comprises cellulosic fibers, the cellulosic fibers can be present in the yarns in any suitable amount. For example, in certain embodiments, the cellulosic fibers can comprise about 35% or more (e.g., about 50% or more), by weight, of the fibers present in one of the pluralities or types of yarn used in making the textile material. In certain embodiments, the cellulosic fibers can comprise about 100%, by weight, of the fibers present in one of the pluralities or types of yarn used in making the textile material. In certain other embodiments, the yarn can include non-cellulosic fibers. In such embodiments, the cellulosic fibers can comprise about 35% to about 100% (e.g., about 50% to about 90%), by weight, of the fibers present in one of the pluralities or types of yarn used in making the textile material. In such embodiments, the remainder of the yarn can be made up of any suitable non-cellulosic fiber or combination of non-cellulosic fibers, such as the thermoplastic synthetic fibers and inherent flame resistant fibers discussed below.

In those embodiments in which the textile material comprises cellulosic fibers, the cellulosic fibers can be present in the textile material in any suitable amount. For example, in certain embodiments, the cellulosic fibers can comprise about 15% or more, about 20% or more, about 25% or more, about 30% or more, or about 35% or more, by weight, of the fibers present in the textile material. While the inclusion of cellulosic fibers can improve the comfort of the textile material (e.g., improve the hand and moisture absorbing characteristics), the inclusion of a high amount of cellulosic fibers can deleteriously affect the durability of the textile material. Accordingly, it may be desirable to limit the amount of cellulosic fiber in the textile material in order to achieve a desired level of durability. Thus, in certain embodiments, the cellulosic fibers can comprise about 75% or less, about 70% or less, about 65% or less, about 60% or less, about 55% or less, about 50% or less, or about 45% or less, by weight, of the fibers present in the textile material. More specifically, in certain embodiments, the cellulosic fibers can comprise about 15% to about 75%, about 20% to about 70%, about 25% to about 65% (e.g., about 25% to about 60%, about 25% to about 55%, about 25% to about 50% or about 25% to about 45%), about 30% to about 60% (e.g., about 30% to about 55%, about 30% to about 50% or about 30% to about 45%), or about 35% to about 55% (e.g., about 35% to about 50% or about 35% to about 45%), by weight, of the fibers present in the textile material.

In certain embodiments of the invention, one or more of the yarns in the textile material can comprise thermoplastic synthetic fibers. For example, the yarn can comprise a blend of cellulosic fibers and thermoplastic synthetic fibers. These thermoplastic synthetic fibers typically are included in the textile material in order to increase its durability to, for example, industrial washing conditions. In particular, thermoplastic synthetic fibers tend to be rather durable to abrasion and harsh washing conditions employed in industrial laundry facilities and their inclusion in, for example, a cellulosic fiber-containing spun yarn can increase that yarns durability to such conditions. This increased durability of the yarn, in turn, leads to an increased durability for the textile material. Suitable thermoplastic synthetic fibers include, but are not necessarily limited to, polyester fibers (e.g., poly(ethylene terephthalate) fibers, poly(propylene terephthalate) fibers, poly(trimethylene terephthalate) fibers), poly(butylene terephthalate) fibers, and blends thereof), polyamide fibers (e.g., nylon 6 fibers, nylon 6,6 fibers, nylon 4,6 fibers, and nylon 12 fibers), polyvinyl alcohol fibers, and combinations, mixtures, or blends thereof.

In those embodiments in which the textile material comprises thermoplastic synthetic fibers, the thermoplastic synthetic fibers can be present in one of the pluralities or types of yarn used in making the textile material in any suitable amount. In certain preferred embodiments, the thermoplastic synthetic fibers comprise about 60% or less or about 50% or less, by weight, of the fibers present in one of the pluralities or types of yarn used in making the textile material. In certain preferred embodiments, the thermoplastic synthetic fibers comprise about 5% or more or about 10% or more, by weight, of the fibers present in one of the pluralities or types of yarn used in making the textile material. Thus, in certain preferred embodiments, the thermoplastic synthetic fibers comprise about 0% to about 65%, about 5% to about 60%, or about 10% to about 50%, by weight, of the fibers present in one of the pluralities or types of yarn used in making the textile material.

In those embodiments in which the textile material comprises thermoplastic synthetic fibers, the thermoplastic synthetic fibers can be present in the textile material in any suitable amount. For example, in certain embodiments, the thermoplastic synthetic fibers can comprise about 1% or more, about 2.5% or more, about 5% or more, about 7.5% or more, or about 10% or more, by weight, of the fibers present in the textile material. The thermoplastic synthetic fibers can comprise about 40% or less, about 35% or less, about 30% or less, about 25% or less, about 20% or less, or about 15% or less, by weight, of the fibers present in the textile material. More specifically, in certain embodiments, the thermoplastic synthetic fibers can comprise about 1% to about 40%, about 2.5% to about 35%, about 5% to about 30% (e.g., about 5% to about 25%, about 5% to about 20%, or about 5% to about 15%), or about 7.5% to about 25% (e.g., about 7.5% to about 20%, or about 7.5% to about 15%), by weight, of the fibers present in the textile material.

In one preferred embodiment, the textile material comprises a plurality of yarns comprising a blend of cellulosic fibers and synthetic fibers (e.g., synthetic staple fibers). In this embodiment, the synthetic fibers can be any of those described above, with polyamide fibers (e.g., polyamide staple fibers) being particularly preferred. In such an embodiment, the cellulosic fibers comprise about 50% to about 90% (e.g., about 60% to about 90%, about 65% to about 90%, about 70% to about 90%, or about 75% to about 90%), by weight, of the fibers present in the yarn, and the polyamide fibers comprise about 10% to about 50% (e.g., about 10% to about 40%, about 10% to about 35%, about 10% to about 30%, or about 10% to about 25%), by weight, of the fibers present in the yarn.

As noted above, certain embodiments of the textile materials of the invention contain yarns comprising inherent flame resistant fibers. As utilized herein, the term “inherent flame resistant fibers” is used to refer to synthetic fibers which, due to the chemical composition of the material from which they are made, exhibit flame resistance without the need for an additional flame retardant treatment. In such embodiments, the inherent flame resistant fibers can be any suitable inherent flame resistant fibers, such as polyoxadiazole fibers, polysulfonamide fibers, poly(benzimidazole) fibers, poly(phenylenesulfide) fibers, meta-aramid fibers, para-aramid fibers, polypyridobisimidazole fibers, polybenzylthiazole fibers, polybenzyloxazole fibers, melamine-formaldehyde polymer fibers, phenol-formaldehyde polymer fibers, oxidized polyacrylonitrile fibers, polyamide-imide fibers and combinations, mixtures, or blends thereof. In certain embodiments, the inherent flame resistant fibers are preferably selected from the group consisting of polyoxadiazole fibers, polysulfonamide fibers, poly(benzimidazole) fibers, poly(phenylenesulfide) fibers, meta-aramid fibers, para-aramid fibers, and combinations, mixtures, or blends thereof. In a more specific embodiment, the inherent flame resistant fibers can be selected from the group consisting of polyoxadiazole fibers, polysulfonamide fibers, poly(benzimidazole) fibers, poly(phenylenesulfide) fibers, and combinations, mixtures, or blends thereof. In certain preferred embodiments, the inherent flame resistant fibers comprise polyoxadiazole fibers.

As utilized herein, the term “polyoxadiazole fibers” refers to fibers containing a polymer comprising oxadiazole groups or units. As will be understood by those of skill in the art, the term “oxadiazole” refers to five-membered, heterocyclic, aromatic groups containing an oxygen atom, two nitrogen atoms, and two carbon atoms, in which at least one of nitrogen atoms is separated from the oxygen atom by a carbon atom. Thus, there are two possible oxadiazole groups: a 1,3,4-oxadiazole group, which has the structure

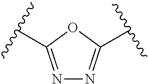

and a 1,2,4-oxadiazole group, which has the structure

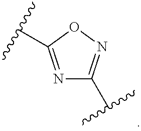

The polyoxadiazole fibers used in the invention can contain a polymer comprising a 1,3,4-oxadiazole group, a 1,2,4-oxadiazole group, or a mixture of the two. The polymer in the polyoxadiazole fibers can contain any other suitable repeating group or unit, with arylene groups being particularly preferred. Thus, the polyoxadiazole fibers can comprise a polyarylene-1,3,4,-oxadiazole polymer, which contains a repeating unit having the structure

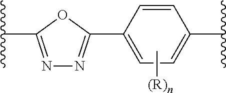

where R represents a non-hydrogen substituent on the aryl group and n is an integer from 0 to 4, or a polyarylene-1,2,4-oxadiazole polymer, which contains a repeating unit having the structure

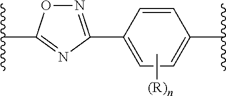

where R represents a non-hydrogen substituent on the aryl group and n is an integer from 0 to 4. Preferably, the polyoxadiazole fibers contain a polyarylene-1,3,4-oxadiazole polymer, such as poly(2-(para-phenylene)-1,3,4-oxadiazole), which corresponds to a polymer containing a repeating unit having the structure depicted above for polyarylene-1,3,4-oxadiazole polymers in which n is 0.

The inherent flame resistant fibers can be present in one of the pluralities or types of yarn used in making the textile material in any suitable amount. For example, in certain embodiments, the inherent flame resistant fibers can comprise about 100%, by weight, of the fibers present in one of the pluralities or types of yarn used in making the textile material in any suitable amount. In those embodiments in which the textile material comprises a yarn containing a blend of cellulosic fibers and inherent flame resistant fibers, the inherent flame resistant fibers can comprise about 5% or more, about 10% or more, about 20% or more, about 30% or more, about 40% or more, or about 50% or more, by weight, of the fibers present in the yarn. Thus, in such embodiments, the inherent flame resistant fibers can comprise about 5% to about 95% or about 10% to about 65%, by weight, of the fibers present in the yarn. More preferably, in such an embodiment, the inherent flame resistant fibers can comprise about 20% to about 50%, by weight, of the fibers present in the yarn.

The inherent flame resistant fibers can be present in the textile material in any suitable amount. Generally, the amount of inherent flame resistant fibers included in the textile material will depend upon the desired properties of the final textile material. In certain embodiments, the inherent flame resistant fibers can comprise about 20% or more, about 25% or more, about 30% or more, about 35% or more, about 40% or more, or about 45% or more, by weight, of the fibers present in the textile material. In certain embodiments, the inherent flame resistant fibers can comprise about 75% or less, about 70% or less, about 65% or less, about 60% or less, about 55% or less, about 50% or less, about 45% or less, or about 40% or less, by weight, of the fibers present in the textile material. Thus, in certain embodiments, the inherent flame resistant fibers can comprise about 20% to about 70%, about 25% to about 75% (e.g., about 25% to about 60%, about 25% to about 50%, about 25% to about 45%, or about 25% to about 40%), about 30% to about 70%, about 35% to about 65%, about 40% to about 60%, or about 45% to about 55%, by weight, of the fibers present in the textile material.

In one potentially preferred embodiment, the textile material comprises a plurality of first yarns disposed in a first direction. The first yarns comprise cellulosic fibers, and optionally, thermoplastic synthetic fibers. The percentage of cellulosic fibers in the first yarn is preferable 35% to 100%. The textile also comprises a plurality of second yarns disposed in a second direction substantially perpendicular to the first direction. The second yarns comprise an inherent flame resistant fiber. The amount of inherent flame resistant fiber in the second yarn preferably ranges from 10% to 100%. The remaining fiber in the second yarn can be cellulosic fibers, thermoplastic synthetic fibers, any other textile fiber, or blends thereof.

As noted above, the invention also provides textile materials that have been treated with one or more flame retardant treatments or finishes to render the textile materials more flame resistant. Typically, such flame retardant treatments or finishes are applied to a textile material containing cellulosic fibers in order to impart flame resistant properties to the cellulosic portion of the textile material. In such embodiments, the flame retardant treatment or finish can be any suitable treatment. Suitable treatments include, but are not limited to, halogenated flame retardants (e.g., brominated or chlorinated flame retardants), phosphorous-based flame retardants, antimony-based flame retardants, nitrogen-containing flame retardants, and combinations, mixtures, or blends thereof.

In one preferred embodiment, the textile material comprises cellulosic fibers and has been treated with a phosphorous-based flame retardant treatment. In this embodiment, a tetrahydroxymethyl phosphonium salt, a condensate of a tetrahydroxymethyl phosphonium salt, or a mixture thereof is first applied to the textile material. As utilized herein, the term “tetrahydroxymethyl phosphonium salt” refers to salts containing the tetrahydroxymethyl phosphonium (THP) cation, which has the structure

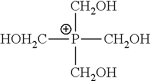

including, but not limited to, the chloride, sulfate, acetate, carbonate, borate, and phosphate salts. As utilized herein, the term “condensate of a tetrahydroxymethyl phosphonium salt” (THP condensate) refers to the product obtained by reacting a tetrahydroxymethyl phosphonium salt, such as those described above, with a limited amount of a cross-linking agent, such as urea, guanazole, or biguanide, to produce a compound in which at least some of the individual tetrahydroxymethyl phosphonium cations have been linked through their hydroxymethyl groups. The structure for such a condensate produced using urea is set forth below

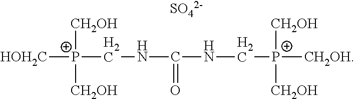

The synthesis of such condensates is described, for example, in Frank et al. (Textile Research Journal, November 1982, pages 678-693) and Frank et al. (Textile Research Journal, December 1982, pages 738-750). These THPS condensates are also commercially available, for example, as PYROSAN® CFR from Emerald Performance Materials.

The THP or THP condensate can be applied to the textile material in any suitable amount. Typically, the THP salt or THP condensate is applied to the textile material in an amount that provides at least 0.5% (e.g., at least 1%, at least 1.5%, at least 2%, at least 2.5%, at least 3%, at least 3.5%, at least 4%, or at least 4.5%) of elemental phosphorus based on the weight of the untreated textile material. The THP salt or THP condensate is also typically applied to the textile in an amount that provides less than 5% (e.g., less than 4.5%, less than 4%, less than 3.5%, less than 3%, less than 2.5%, less than 2%, less than 1.5%, or less than 1%) of elemental phosphorus based on the weight of the untreated textile material. Preferably, the THP salt or THP condensate is applied to the textile material in an amount that provides about 1% to about 4% (e.g., about 1% to about 3% or about 1% to about 2%) of elemental phosphorous based on the weight of the untreated textile material.

Once the THP salt or THP condensate has been applied to the textile material, the THP salt or THP condensate is then reacted with a cross-linking agent. The product produced by this reaction is a cross-linked phosphorus-containing flame retardant polymer. The cross-linking agent is any suitable compound that enables the cross-linking and/or curing of THP. Suitable cross-linking agents include, for example, urea, a guanidine (i.e., guanidine, a salt thereof, or a guanidine derivative), guanyl urea, glycoluril, ammonia, an ammonia-formaldehyde adduct, an ammonia-acetaldehyde adduct, an ammonia-butyraldehyde adduct, an ammonia-chloral adduct, glucosamine, a polyamine (e.g., polyethyleneimine, polyvinylamine, polyetherimine, polyethyleneamine, polyacrylamide, chitosan, aminopolysaccharides), glycidyl ethers, isocyanates, blocked isocyanates and combinations thereof. Preferably, the cross-linking agent is urea or ammonia, with urea being the more preferred cross-linking agent.

The cross-linking agent can be applied to the textile material in any suitable amount. The suitable amount of cross-linking agent varies based on the weight of the textile material and its construction. Typically, the cross-linking agent is applied to the textile material in an amount of at least 0.1% (e.g., at least 1%, at least 2%, at least 3%, at least 5%, at least 7%, at least 10%, at least 15%, at least 18%, or at least 20%) based on the weight of the untreated textile material. The cross-linking agent is also typically applied to the textile material in an amount of less than 25% (e.g., less than 20%, less than 18%, less than 15%, less than 10%, less than 7%, less than 5%, less than 3%, or less than 1%) based on the weight of the untreated textile material. In a potentially preferred embodiment, the cross-linking agent is applied to the textile material in an amount of about 2% to about 7% based on the weight of the untreated textile material.

In order to accelerate the condensation reaction of the THP salt or THP condensate and the cross-linking agent, the above-described reaction can be carried out at elevated temperatures. The time and elevated temperatures used in this curing step can be any suitable combinations of times and temperatures that result in the reaction of the THP or THP condensate and cross-linking agent to the desired degree. The time and elevated temperatures used in this curing step can also promote the formation of covalent bonds between the cellulosic fibers and the phosphorous-containing condensation product, which is believed to contribute the durability of the flame retardant treatment. However, care must be taken not to use excessively high temperatures or excessively long cure times that might result in excessive reaction of the flame retardant with the cellulosic fibers, which might weaken the cellulosic fibers and the textile material. Furthermore, it is believed that the elevated temperatures used in the curing step can allow the THP salt or THP condensate and cross-linking agent to diffuse into the cellulose fibers where they react to form a cross-linked phosphorus-containing flame retardant polymer within the fibers. Suitable temperatures and times for this curing step will vary depending upon the curing oven used and the speed with which heat is transferred to the textile material, but suitable conditions can range from temperatures of about 149° C. (300° F.) to about 177° C. (350° F.) and times from about 1 minute to about 3 minutes.

In the case where ammonia is used as the cross-linking agent, it is not necessary to use elevated temperatures for the THP salt or THP condensate and cross-linking agent to react. In such case, the reaction can be carried out, for example, in a gas-phase ammonia chamber at ambient temperature. A suitable process for generating a phosphorous-based flame retardant using this ammonia-based process is described, for example, in U.S. Pat. No. 3,900,664 (Miller), the disclosure of which is hereby incorporated by reference.

After the THP salt or THP condensate and cross-linking agent have been cured and allowed to react to the desired degree, the resulting textile material can be exposed to an oxidizing agent. While not wishing to be bound to any particular theory, it is believed that this oxidizing step converts the phosphorous in the condensation product (i.e., the condensation product produced by the reaction of the THP salt or THP condensate and cross-linking agent) from a trivalent form to a more stable pentavalent form. The resulting phosphorous-containing compound (i.e., cross-linked, phosphorous-containing flame retardant polymer) is believed to contain a plurality of pentavalent phosphine oxide groups. In those embodiments in which urea has been used to cross-link the THP salt or THP condensate, the phosphorous-containing compound comprises amide linking groups covalently bonded to the pentavalent phosphine oxide groups, and it is believed that at least a portion of the phosphine oxide groups have three amide linking groups covalently bonded thereto.

The oxidizing agent used in this step can be any suitable oxidant, such as hydrogen peroxide, sodium perborate, or sodium hypochlorite. The amount of oxidant can vary depending on the actual materials used, but typically the oxidizing agent is incorporated in a solution containing at least 0.1% concentration (e.g., at least 0.5%, at least 0.8, at least 1%, at least 2%, or at least 3% concentration) and less than 20% concentration (e.g., less than 15%, less than 12%, less than 10%, less than 3%, less than 2%, or less than 1% concentration) of the oxidant.

After contacting the treated textile material with the oxidizing agent, the cured textile material preferably is contacted with a neutralizing solution (e.g., a caustic solution with a pH of at least 8, at least pH 9, at least pH 10, at least pH 11, or at least pH 12). The actual components of the caustic solution can widely vary, but suitable components include any strong base, such as alkalis. For example, sodium hydroxide (soda), potassium hydroxide (potash), calcium oxide (lime), or any combination thereof can be used in the neutralizing solution. The amount of base depends on the size of the bath and is determined by the ultimately desired pH level. A suitable amount of caustic in the solution is at least 0.1% concentration (e.g., at least 0.5%, at least 0.8, at least 1%, at least 2%, or at least 3% concentration) and is less than 10% concentration (e.g., less than 8%, less than 6%, less than 5%, less than 3%, less than 2%, or less than 1% concentration). The contact time of the treated textile material with the caustic solution varies, but typically is at least 30 seconds (e.g., at least 1 min, at least 3 min, at least 5 min, or at least 10 min). If desired, the neutralizing solution can be warmed (e.g., up to 75° C., up to 70° C., up to 60° C., up to 50° C., up to 40° C., up to 30° C. relative to room temperature).

If desired, the textile material can be treated with one or more softening agents (also known as “softeners”) to improve the hand of the treated textile material. The softening agent selected for this purpose should not have a deleterious effect on the flammability of the resultant fabric. Suitable softeners include polyolefins, ethoxylated alcohols, ethoxylated ester oils, alkyl glycerides, alkylamines, quaternary alkylamines, halogenated waxes, halogenated esters, silicone compounds, and mixtures thereof.

To further enhance the textile material's hand, the textile material can optionally be treated using one or more mechanical surface treatments. A mechanical surface treatment typically relaxes stress imparted to the fabric during curing and fabric handling, breaks up yarn bundles stiffened during curing, and increases the tear strength of the treated fabric. Examples of suitable mechanical surface treatments include treatment with high-pressure streams of air or water (such as those described in U.S. Pat. No. 4,918,795, U.S. Pat. No. 5,033,143, and U.S. Pat. No. 6,546,605), treatment with steam jets, needling, particle bombardment, ice-blasting, tumbling, stone-washing, constricting through a jet orifice, and treatment with mechanical vibration, sharp bending, shear, or compression. A sanforizing process may be used instead of, or in addition to, one or more of the above processes to improve the fabric's hand and to control the fabric's shrinkage. Additional mechanical treatments that may be used to impart softness to the treated fabric, and which may also be followed by a sanforizing process, include napping, napping with diamond-coated napping wire, gritless sanding, patterned sanding against an embossed surface, shot-peening, sand-blasting, brushing, impregnated brush rolls, ultrasonic agitation, sueding, engraved or patterned roll abrasion, and impacting against or with another material, such as the same or a different fabric, abrasive substrates, steel wool, diamond grit rolls, tungsten carbide rolls, etched or scarred rolls, or sandpaper rolls.

The following examples further illustrate the subject matter described above but, of course, should not be construed as in any way limiting the scope thereof.

### Example

This example demonstrates the performance of a flame resistant textile material according to the invention and compares that performance to that exhibited by certain commercially available flame resistant fabrics.

A woven fabric (Sample 1) was produced by interlacing a plurality of first and second yarns. The first yarns, which were disposed in the warp direction of the fabric, comprised a blend of approximately 75% cotton fibers and approximately 25% nylon fibers based on the total weight of the yarn. The first yarns were ring spun, single ply yarns having a cotton count of 18. The second yarns, which were disposed in the filling direction of the fabric, comprised 100% poly(oxadiazole) fibers (i.e., poly(2-(para-phenylene)-1,3,4-oxadiazole) fibers). The fiber used in the second yarns is commercially available as staple fiber and sold under the trade name ARSELON by RUE Svetlogorsk PA Khimvolokno (Svetlogorsk, Gomel reg, Republic of Belarus). The second yarns were open-end spun, single ply having a cotton count of 13. The plurality of first and second yarns were woven in a 4×1 warp-faced sateen weave which comprised approximately 52 weight percent of the first yarns and 48 weight percent of the second yarns. The resulting fabric had a fabric weight of approximately 6.69 oz per square yard, contained approximately 80 ends per inch and contained approximately 46 picks per inch.

The fabric was prepared on a standard open-width continuous preparation range following the steps of desizing, bleaching, mercerizing, washing and drying. The fabric was further dyed a navy color on a standard open-width dyeing range with vat dyestuffs by the thermosol dyeing process incorporating reduction and oxidation processes to affect dyeing of the cellulose fibers.

A flame retardant treatment was applied to the fabric in the following manner. The fabric was passed through a pad bath of a tetrahydroxymethyl phosphonium (THP) precondensate sulfate salt, urea, and cationic softener before entering a curing oven. The THP salt concentration was about 40% by weight of the formulation solution.

The THP salt was reacted on the fabric with urea to create an intermediate compound in which the phosphorous compound is present in its trivalent form. Such reaction was carried out in the fabric at a temperature of about 166° C. (about 330° F.) for about 1 minute to cause the THP condensate to form covalent bonds with the cellulosic fibers, thus imparting greater durability of the flame retardant treatment to washing. The treated fabric was then conveyed through a peroxide bath, in which the peroxide oxidizes the phosphorous compound to fix the flame retardant compound to the fabric surface and to convert the trivalent phosphorous to its stable pentavalent form.

Following the flame retardant treatment the fabric was again dried and taken-up for further processing. The fabric was taken to a tenter range for finishing and passed through a pad which contained a formaldehyde scavenger, and a high-density polyethylene used as a lubricant. The fabric was overfed onto the tenter pins at about 3% overfeed and dried in ovens set at about 138° C. (280° F.) for about 70 seconds.

After chemical finishing, the fabric was subjected to mechanical treatment via a plurality of high pressure (40-90 psig) air jets, which induced vibration in the fabric and which resulted in a softening of the fabric hand and an improvement in tear strength. This mechanical treatment is described in detail in U.S. Pat. No. 4,837,902; U.S. Pat. No. 4,918,795; and U.S. Pat. No. 5,822,835, all to Dischler. Following the mechanical treatment, the fabric was processed through a sanforizor to compact and pre-shrink the fabric.

Two commercially-available flame resistant fabrics were obtained for purposes of comparison. The first comparative fabric (Comparative Sample 1) was a commercially available flame-resistant 7.5 oz per square yard, 3×1 twill weave fabric from Westex. The woven fabric was obtained from commercial coveralls purchased in 2008. The warp yarns were a 75% cotton and 25% nylon blend by weight and the filling yarns were 100% cotton. It is believed that the fabric was treated with the THP-based, ammonia-cure flame retardant treatment process disclosed in the specification and a subsequent mechanical treatment.

The second comparative fabric (Comparative Sample 2) was a commercially available flame-resistant 6.0 oz per square yard, plain weave fabric. The fabric was a 1×1 weave constructed using a 2-ply warp yarn with a cotton count of 30 and a 2-ply filling yarn with a cotton count of 30. Both yarns contained a blend of approximately 93% by weight meta-aramid fibers (i.e., NOMEX® fibers commercially available from DuPont), approximately 5% by weight para-aramid (i.e., KEVLAR® fibers commercially available from DuPont), and approximately 2% by weight static dissipative fibers (i.e., P140 antistatic carbon fibers), the blend being commercially available from DuPont as NOMEX® IIIA.

The samples were then subjected to several tests to determine their relevant performance. Due to the cost associated with these tests, Applicants have not independently replicated all of these tests on the comparative fabrics. Rather, in certain cases, Applicants have relied upon the values reported by the manufacturer of the fabric or fiber blend. When a manufacturer's value is reported, Applicants have indicated the same in the Table.

The fabric examples were evaluated for flammability performance and durability using a vertical flame test apparatus according to Standard Test Method ASTM D 6413, entitled “Standard Test Method for Flame Resistance of Textiles (Vertical Test). The test method provides a measure of a fabric's char length and ability to self-extinguish after a 12 second flame exposure and was performed after 100 industrial launderings according the wash method of NFPA 2112-2007.

The fabric examples were evaluated for flammability performance using an instrumented manikin (commonly referred to as “PYROMAN®”) device according to Test Method ASTM F1930 entitled “Standard Test Method for Evaluation of Flame Resistant Clothing for Protection Against Flash Fire Simulations Using an Instrumented Manikin,” using a four-second exposure time. This test method provides a measurement of garment and clothing ensemble performance on a stationary upright mannequin when exposed to a flash fire at a calibrated 2.0 calorie/cm² s heat flux as determined by a set of sensors embedded in the manikin skin. A percentage body burn of less than 50% is considered passing according to the industry standard, NFPA 2112-2007.

The fabric examples were also evaluated for arc protection, according to Test Method ASTM F1959 entitled “Standard Test Method for Determining the Arc Rating of Materials for Clothing.” This test method is intended for the determination of the arc rating of a material, or a combination of materials. The numbers reported below are the Arc Thermal Performance Values (ATPV) for each example, where higher numbers indicate better protection from thermal burns. An arc rating of at least 4 cal/cm² but less than 8 cal/cm² is appropriate for Hazard/Risk Category (HRC) 1, an arc rating of at least 8 cal/cm² but less than 25 cal/cm² meets HRC 2, an arc rating of at least 25 cal/cm² but less than 40 cal/cm² meets HRC 3 and an arc rating of at least 40 cal/cm² meets HRC 4.

The results of the tests are reported in the Table below. In the Table, an asterisk (*) indicates a value that has been reported by the manufacturer.

TABLE
Physical Attributes and Flame Resistance (FR) performance for Sample 1
and Comparative Samples (C.S.) 1 and 2.

| | | |
|---|---|---|
| Sample 1 | C.S. 1 | C.S. 2 |

Physical Attributes

| | | | |
|---|---|---|---|
| Weave Type | 4 × 1 Sateen | 3 × 1 Twill | 1 × 1 Plain |
| Warp Yarn | 75%/25% | 75%/25% | 100% Nomex |
| | cotton/nylon | cotton/nylon | IIIA |
| Filling Yarn | 100% | 100% cotton | 100% Nomex |
| | polyoxadiazole | | IIIA |
| Overall Blend | 48% | 88% cotton | 93% meta- |
| | polyoxadiazole | 12% nylon | aramid fibers |
| | 39% cotton | | 5% para- |
| | 13% nylon | | aramid |
| | | | 2% static |
| | | | dissipative |
| | | | fibers |
| Weight (oz/yd²) | 6.69 | 7.60 | 6.0 |

FR Performance

| | | | |
|---|---|---|---|
| VERTICAL FLAME - | 2.69 | 3.58 | 2.90* |
| 100 W warp char length | | | |
| (inches) | | | |
| ARC RATING - ATPV | 9.1 | 8.7* | 5.6* |
| (cal/cm2) | | | |
| PYROMAN - % | 45.3 | 69.0* | 44.3* |
| Body Burn (4 s) | | | |

As can be seen from the data set forth in the Table, a fabric according to the invention (Sample 1) exhibits flame resistance properties that are far better than the properties exhibited by the commercially-available FR cotton-nylon product (i.e., Comparative Sample 1). For example, the results of the vertical flame and Pyroman tests show that a fabric according to the invention exhibits values that are approximately twenty-five percent and thirty-four percent lower than the values exhibited by the commercially-available FR cotton-nylon product. The data set forth in the Table also demonstrates that the flame resistant properties of the inventive fabric are comparable to those exhibited by a fabric made using a high aramid fiber content (i.e., Comparative Sample 2). Indeed, the results demonstrate that the inventive fabric exhibits far better arc protection than Comparative Sample 2, achieving a Hazard/Risk Category (HRC) 2 rating.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A textile material having a first surface and a second surface opposite the first surface, the textile material comprising:
(a) a plurality of first yarns disposed in a first direction, the first yarns comprising cellulosic fibers; and
(b) a plurality of second yarns disposed in a second direction substantially perpendicular to the first direction, the second yarns comprising polyoxadiazole fibers;
wherein the first and second yarns are disposed in a patternwise arrangement in which the first yarns are predominantly disposed on the first surface of the textile material and the second yarns are predominantly disposed on the second surface of the textile material.

2. The textile material of claim 1, wherein the cellulosic fibers comprise about 50% or more, by weight, of the fibers present in the first yarns.

3. The textile material of claim 1, wherein the cellulosic fibers comprise about 100%, by weight, of the fibers present in the first yarns.

4. The textile material of claim 1, wherein the first yarns further comprise synthetic fibers selected from the group consisting of polyester fibers, polyamide fibers, polyvinyl alcohol fibers, and mixtures thereof.

5. The textile material of claim 4, wherein the first yarns comprise cellulosic fibers and polyamide fibers.

6. The textile material of claim 5, wherein the cellulosic fibers comprise about 50% to about 90%, by weight, of the fibers present in the first yarns, and the polyamide fibers comprise about 10% to about 50%, by weight, of the fibers present in the first yarns.

7. The textile material of claim 1, wherein the polyoxadiazole fibers comprise about 5% to about 100%, by weight, of the fibers present in the second yarns.

8. The textile material of claim 3, wherein the polyoxadiazole fibers comprise about 100%, by weight, of the fibers present in the second yarns.

9. The textile material of claim 1, wherein the first and second yarns are spun yarns.

10. The textile material of claim 1, wherein the first and second yarns are disposed in a woven pattern selected from the group consisting of sateen weaves and twill weaves.

11. A textile material comprising:
(a) a plurality of first yarns, the first yarns comprising cellulosic fibers and fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof; and
(b) a finish applied to the textile material, the finish comprising a phosphorous-containing compound polymerized within at least a portion of the cellulosic fibers, the phosphorous-containing compound being a product produced by heat-curing and oxidizing a reaction mixture comprising:
(i) a first chemical selected from the group consisting of tetrahydroxymethyl phosphonium salts, condensates of tetrahydroxymethyl phosphonium salts, and mixtures thereof; and
(ii) a cross-linking agent selected from the group consisting of urea, guanidines, guanyl urea, glycoluril, ammonia, ammonia-formaldehyde adducts, ammonia-acetaldehyde adducts, ammonia-butyraldehyde adducts, ammonia-chloral adducts, glucosamine, polyamines, glycidyl ethers, isocyanates, blocked isocyanates, and mixtures thereof.

12. The textile material of claim 11, wherein the plurality of first yarns are disposed in a first direction and the textile material further comprises a plurality of second yarns disposed in a second direction substantially perpendicular to the first direction, the second yarns comprising cellulosic fibers and fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof.

13. The textile material of claim 12, wherein the first and second yarns comprise cellulosic fibers and polyoxadiazole fibers.

14. A textile material having a first surface and a second surface opposite the first surface, the textile material comprising:
(a) a plurality of first yarns disposed in a first direction, the first yarns comprising cellulosic fibers;
(b) a plurality of second yarns disposed in a second direction substantially perpendicular to the first direction, the second yarns comprising fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof; and
(c) a finish applied to the textile material, the finish comprising a phosphorous-containing compound, the phosphorous-containing compound comprising a plurality of pentavalent phosphine oxide groups having amide linking groups covalently bonded thereto, at least a portion of the pentavalent phosphine oxide groups having three amide linking groups covalently bonded thereto;
wherein the first and second yarns are disposed in a patternwise arrangement in which the first yarns are predominantly disposed on the first surface of the textile material and the second yarns are predominantly disposed on the second surface of the textile material.

15. The textile material of claim 14, wherein the cellulosic fibers comprise about 50% or more, by weight, of the fibers present in the first yarns.

16. The textile material of claim 1, wherein the cellulosic fibers comprise about 100%, by weight, of the fibers present in the first yarns.

17. The textile material of claim 14, wherein the first yarns further comprise thermoplastic synthetic fibers selected from the group consisting of polyester fibers, polyamide fibers, polyvinyl alcohol fibers, and mixtures thereof.

18. The textile material of claim 17, wherein the first yarns comprise cellulosic fibers and polyamide fibers.

19. The textile material of claim 18, wherein the cellulosic fibers comprise about 50% to about 90%, by weight, of the fibers present in the first yarns, and the polyamide fibers comprise about 10% to about 50%, by weight, of the fibers present in the first yarns.

20. The textile material of claim 14, wherein the second yarns comprise polyoxadiazole fibers and the polyoxadiazole fibers comprise about 5% to about 100%, by weight, of the fibers present in the second yarns.

21. The textile material of claim 16, wherein the second yarns comprise polyoxadiazole fibers and the polyoxadiazole fibers comprise about 100%, by weight, of the fibers present in the second yarns.

22. The textile material of claim 14, wherein the first and second yarns are spun yarns.

23. A textile material having a first surface and a second surface opposite the first surface, the textile material comprising:
(a) a plurality of first yarns disposed in a first direction, the first yarns comprising cellulosic fibers;
(b) a plurality of second yarns disposed in a second direction substantially perpendicular to the first direction, the second yarns comprising fibers selected from the group consisting of polyoxadiazole fibers, polysulfonamide fibers, poly(benzimidazole) fibers, poly(phenylenesulfide) fibers, meta-aramid fibers, para-aramid fibers, and mixtures thereof; and
(c) a finish applied to the textile material, the finish comprising a phosphorous-containing compound polymerized within at least a portion of the cellulosic fibers, the phosphorous-containing compound being a product produced by heat-curing and oxidizing a reaction mixture comprising:
(i) a first chemical selected from the group consisting of tetrahydroxymethyl phosphonium salts, condensates of tetrahydroxymethyl phosphonium salts, and mixtures thereof; and
(ii) a cross-linking agent selected from the group consisting of urea, guanidines, guanyl urea, glycoluril, ammonia, ammonia-formaldehyde adducts, ammonia-acetaldehyde adducts, ammonia-butyraldehyde adducts, ammonia-chloral adducts, glucosamine, polyamines, glycidyl ethers, isocyanates, blocked isocyanates, and mixtures thereof;
wherein the first and second yarns are disposed in a patternwise arrangement in which the first yarns are predominantly disposed on the first surface of the textile material and the second yarns are predominantly disposed on the second surface of the textile material.

24. The textile material of claim 23, wherein the cellulosic fibers comprise about 50% or more, by weight, of the fibers present in the first yarns.

25. The textile material of claim 23, wherein the cellulosic fibers comprise about 100%, by weight, of the fibers present in the first yarns.

26. The textile material of claim 23, wherein the first yarns further comprise thermoplastic synthetic fibers selected from the group consisting of polyester fibers, polyamide fibers, polyvinyl alcohol fibers, and mixtures thereof.

27. The textile material of claim 26, wherein the first yarns comprise cellulosic fibers and polyamide fibers.

28. The textile material of claim 27, wherein the cellulosic fibers comprise about 50% to about 90%, by weight, of the fibers present in the first yarns, and the polyamide fibers comprise about 10% to about 50%, by weight, of the fibers present in the first yarns.

29. The textile material of claim 23, wherein the second yarns comprise polyoxadiazole fibers and the polyoxadiazole fibers comprise about 5% to about 100%, by weight, of the fibers present in the second yarns.

30. The textile material of claim 25, wherein the second yarns comprise polyoxadiazole fibers and the polyoxadiazole fibers comprise about 100%, by weight, of the fibers present in the second yarns.

31. The textile material of claim 23, wherein the first and second yarns are spun yarns.
